(19) United States
(12) Patent Application Publication
(10) Pub. No.: US 2015/0097976 A1
(43) Pub. Date: Apr. 9, 2015

(54) IMAGE PROCESSING DEVICE AND IMAGE PROCESSING METHOD

(71) Applicant: Panasonic Corporation, Osaka (JP)

(72) Inventors: Atsushi Nakanishi, Nara (JP); Shinya Kiuchi, Osaka (JP)

(21) Appl. No.: 14/360,770

(22) PCT Filed: Dec. 7, 2012
(86) PCT No.: PCT/JP2012/007856

§ 371 Date: May 27, 2014

(30) Foreign Application Priority Data
Dec. 14, 2011 (JP) 2011-273157

(51) Int. Cl. H04N 5/232

(52) U.S. Cl. CPC H04N 5/23267; H04N 5/23254
USPC 348/208.1

(57) ABSTRACT

An image processing device which executes image processing on an input image includes: an identifying unit identifying a first moving image area which is a portion of the input image and includes a first moving image; a camera shake amount calculating unit calculating a camera shake amount in the first moving image area; a correction unit generating a first correction image by correcting the first moving image area to reduce the camera shake amount; and a compositing unit generating a composite image by replacing the first moving image area in the input image with the first correction image.

### TECHNICAL FIELD

The present disclosure relates to an image processing device and an image processing method for stabilizing images in video content provided via such media as broadcasting, recording appliances, and the Internet.

### BACKGROUND ART

Recent ubiquity of moving-image sharing websites on the Internet requires image processing devices, such as TVs, to display and process various kinds of moving image content. Such moving-image sharing websites allow a user to share moving images obtained himself or herself with another user. Hence, users are seeing increasing opportunities to watch the shared moving image on TV.

Here, the users often obtain moving images by cameras included in cellular phones and smart phones. Quite a few moving images obtained by cellular phone cameras and smart phone cameras suffer from blur due to camera shake in obtaining the moving images. This is because cellular phones and smart phones are small capturing appliances in size, and such small-sized appliances inevitably cause camera shake.

In contrast, a large number of capturing devices specialized in obtaining moving images, such as camcorders, employ image stabilization functions (see Patent Literatures, PTLs, 1 and 2, for example). Such functions can provide a clear video having reduced camera shake in capturing moving images.

It is difficult, however, to equip a small capturing device, such as a cellular phone and a smart phone, with high-quality image stabilization functions employed for a camcorder. Consequently, users face difficulties in using cellular phones and smart phones for obtaining moving image having reduced camera shake.

### CITATION LIST

### Patent Literature

### [PTL 1]

Japanese Unexamined Patent Application Publication No. 07-123364

### [PTL 2]

Japanese Unexamined Patent Application Publication No. 04-117077

### SUMMARY OF INVENTION

### Technical Problem

PTLs 1 and 2 face a challenge in that how to display on a display device a video which includes a blurred moving image that is obtained by appliances, such as a smart phone, so that the displayed video is easy for the user to watch.

The present disclosure alms to provide an Image processing device which successfully displays on a display device a video which includes a blurred moving image, so that the blur may be reduced from the moving image.

### Solution to Problem

In order to solve the above problems, an image processing device according to the present disclosure executes image processing on an input image. The image processing device includes: an identifying unit which identifies a first moving image area that is a portion of the input image and includes a first moving image; a camera shake amount calculating unit which calculates a camera shake amount in the first moving image area; a correction unit which generates a first correction image by correcting the first moving image area to reduce the camera shake amount; and a compositing unit which generates a composite image by replacing the first moving image area in the input image with the first correction image.

### Advantageous Effects of Invention

An image processing device according to an implementation of the present disclosure successfully displays on a display device a video which includes a blurred moving image so that the blur may be reduced from the moving image.

### BRIEF DESCRIPTION OF DRAWINGS

FIG. 1 represents a block diagram illustrating a structure of an image processing device according to Embodiment 1.

FIG. 2 represents an example of an input image including a moving image area and a non-moving-image area.

FIG. 3 represents another example of an input image including a moving image area and a non-moving-image area.

FIG. 4 represents still another example of an input image including a moving image area and a non-moving-image area.

FIG. 5 represents a flowchart representing operations of an image processing device.

FIG. 6 represents an example of how to correct a cropped image by shifting a read position in a memory space.

FIG. 7 represents an example of masking.

FIG. 8 represents how to control mask width.

FIG. 9 represents a demonstration mode.

FIG. 10 represents a block diagram illustrating a structure of an image processing device according to Embodiment 2.

FIG. 11 represents an example of an input image simultaneously displaying two moving images.

FIG. 12 represents a block diagram illustrating a structure of an image processing device according to Embodiment 3.

FIG. 13 represents an example of an input image including multiple moving image areas and a non-moving-image area.

FIG. 14 represents an appearance of a TV set.

### DESCRIPTION OF EMBODIMENTS

### Underlying Knowledge Forming Basis of the Present Disclosure

When a picture includes a blurred moving image obtained by appliances such as a smart phone, the picture is not eye-friendly to a user. A solution to the problem would be to provide such a picture with image stabilization when the picture is displayed (displayed and processed) on a display device. The image stabilization on the picture can be implemented by application of an electronic image stabilization technique employed for appliances such as camcorders.

The conventional electronic image stabilization technique, however, was developed on the assumption of utilization for camcorders. Hence the conventional technique faces various challenges when correcting a picture, which includes an already-obtained moving image, at the moment of displaying and correcting the picture.

One of the challenges is that it is difficult to provide the image stabilization to a moving image when a picture to be displayed on a display screen is partly the moving image.

When a user is viewing a moving-image-sharing website on a Web browser, for example, the picture for the user to watch displays a moving image only on an area of the display screen and a still image including a text image on another area of the display screen. In such a case, the above electronic image stabilization technique cannot appropriately detect a camera shake amount.

This is because the conventional image stabilization detects motion vectors in the picture on the entire display screen, calculates a direction and a largeness of camera shake (camera shake amount) based on the detected motion vectors, and executes image stabilization by shifting the entire picture in a direction counter to the direction of the camera shake. In other words, the conventional image stabilization technique inevitably shifts the entire picture, which shifts not only the moving image area included in the picture but also a non-moving-image area. Shifting the entire picture causes unnecessary shake on the non-moving-image area in the picture.

Due to a similar reason, the conventional image stabilization technique cannot appropriately provide image stabilization to a picture including two or more different moving images.

Furthermore, there is still another challenge: when the image stabilization is executed only on the moving picture in a moving-picture-including video to shift the moving image area, the shift creates a portion with image data missing at an end of the moving image area.

In such a case, the moving image could be enlarged so as to hide the portion where the image data is missing. Such a technique, however, causes a problem that the edge portion of the original moving image area does not fit in the picture.

The present invention is conceived in view of the above problems and aims to perform appropriate image stabilization under conditions where an input image, which is one of multiple frames included in an input video, includes (i) a moving image area and a non-moving-image area or (ii) multiple moving image areas.

In addition, the present invention aims to reduce deterioration in moving image quality caused when a portion where image data is missing appears on an edge of a moving image area.

Described hereinafter are embodiments with reference to the drawings. It is noted that excessively detailed explanations may be omitted. Exemplary detailed explanations to be omitted include detailed descriptions for known arts and repetitive descriptions for substantially identical structures. This is to keep the description below from being unnecessarily redundant, and facilitate understanding of the present disclosure by the persons skilled in the art.

It is noted that the inventors provide the attached drawings and the description below in order for the persons skilled in the art to fully understand the present disclosure. The attached drawings and the description below shall not limit the subject matter recited in the claims.

### Embodiment 1

### 1-1. Structure

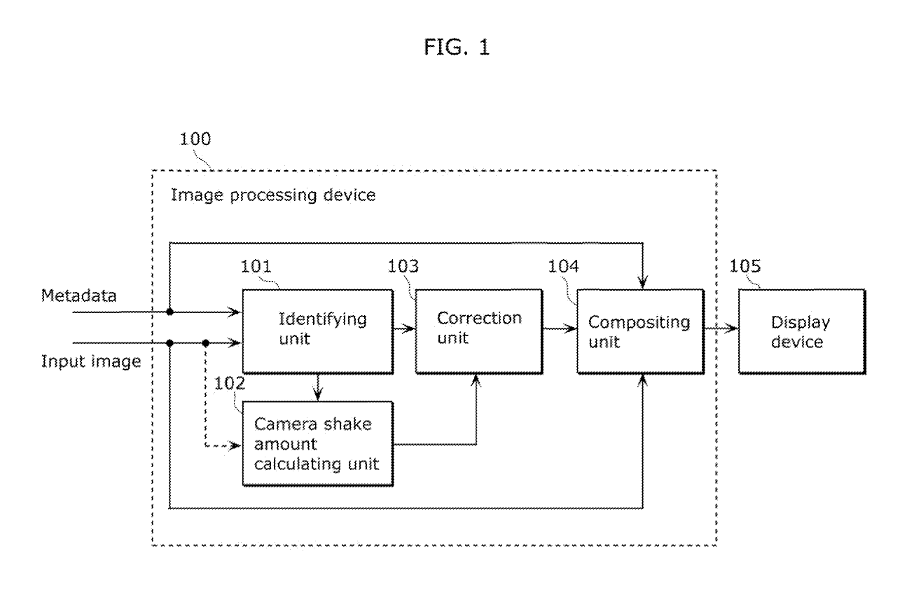

FIG. 1 represents a block diagram illustrating a structure of an image processing device according to Embodiment 1.

An image processing device 100 executes image processing on an input image which is one of multiple frames included in an input video (picture signal).

The image processing device 100 includes an identifying unit 101, a camera shake amount calculating unit 102, a correction unit 103, and a compositing unit 104. FIG. 1 also represents a display device 105 provided outside the image processing device 100.

The identifying unit 101 identifies a moving image area included in an input image and displaying a moving image.

The camera shake amount calculating unit 102 calculates a camera shake amount in the moving image area included in the input image.

The correction unit 103 generates a correction image by correcting an image corresponding to the moving image area based on the camera shake amount calculated by the camera shake amount calculating unit 102.

The compositing unit 104 composites the moving image area in the input image with the correction image generated by the correction unit 103, and generates a composite image.

The display device 105 may include, for example, a liquid crystal display, a plasma display, and an organic electro luminescence (EL) display. The image processing device 100 may include a displaying unit.

An assumed case in Embodiment 1 is that an input video displays moving image only in a selected area of the screen (the area that displays a moving image may also be referred to as moving image area, hereinafter) and a still picture such as text messages in the other area of the screen.

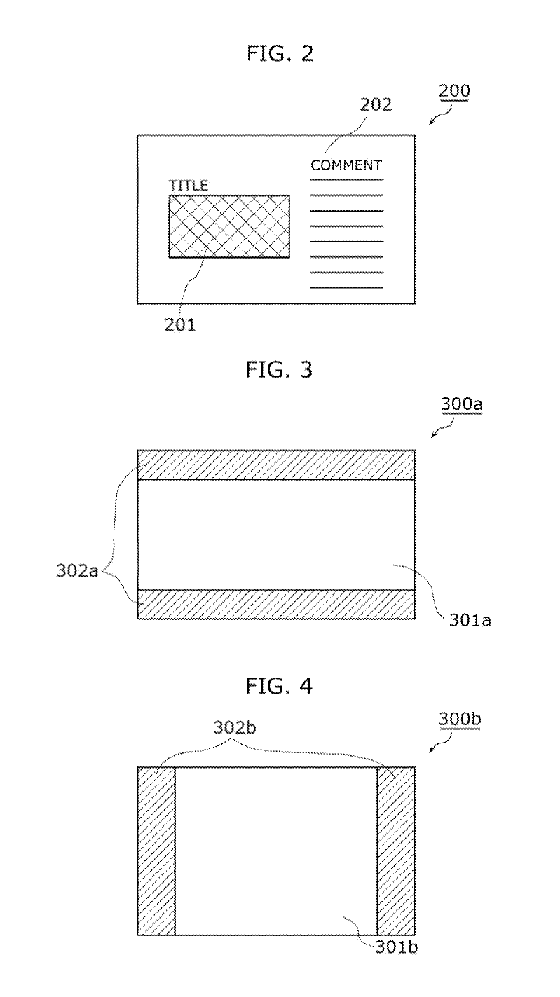

FIG. 2 represents an input image including a moving image area and a non-moving-image area.

FIG. 2 represents a screen in viewing a website. A moving image area 201 in an input image 200 displays a moving image. The input image 200 exemplifying a non-moving-image area 202 provided to surround the moving image area 201 and displaying a text message.

FIGS. 3 and 4 represent other examples of an input image including a moving image area and a non-moving-image area.

FIG. 3 is an input image 300a which is letterboxed and provided with non-moving-image areas 302a that are vertically placed above and below an image moving image area 301a.

FIG. 4 is an input image 300b which is pillerboxed and provided with non-moving-image areas 302b that are horizontally placed on the sides of a moving image area 301b.

In Embodiment 1, the input image represented in one of the FIGS. 2 to 4 is to receive processing executed by the image processing device 100.

### 1-2. Operations

Detailed next are the operations of the image processing device 100.

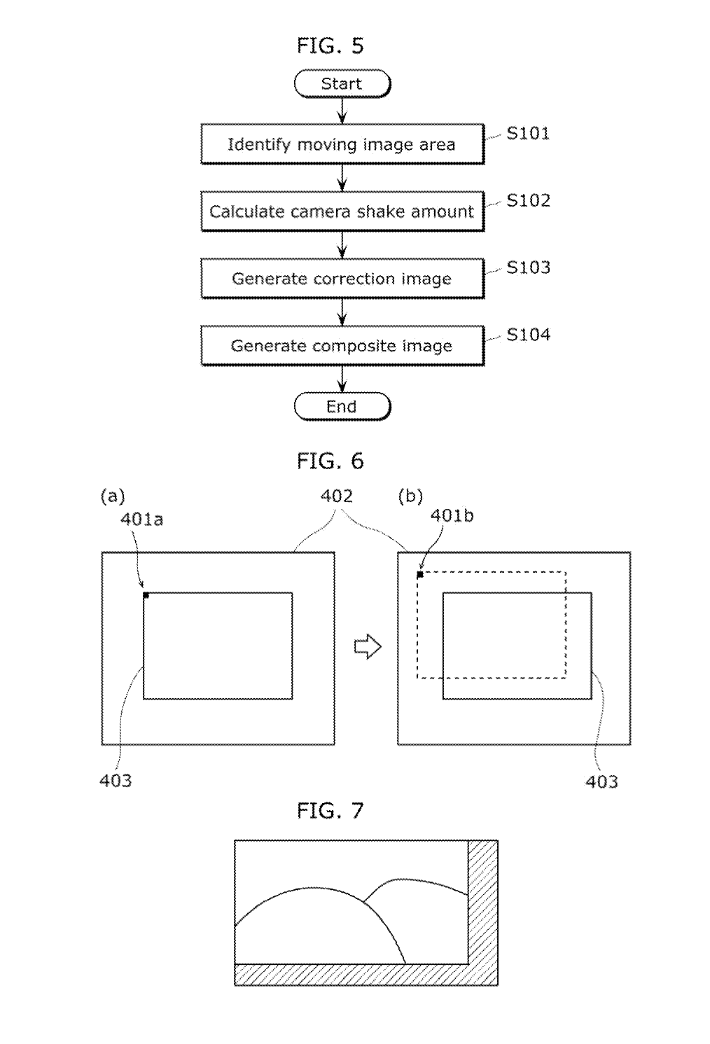

FIG. 5 represents a flowchart representing the operations of the image processing device 100.

First, the identifying unit 101 identifies a moving image area included in an input image (S101).

In Embodiment 1, the identifying unit 101 obtains the input image and metadata which indicates the position of the moving image area in the input image, and identifies the moving image area using the obtained metadata.

Specifically, the metadata is a 1-bit signal which represents, for each of the pixels in the input image, “1” in the moving image area and “0” in the non-moving-image area.

Furthermore, the metadata may indicate an (x, y) coordinate of the moving image area, as well as the width and the height of the moving image area. Here, to identify the moving image area, the identifying unit 101 converts, for each pixel in the input image, information on the coordinate, the width, and the height into a 1-bit signal representing 1 in the moving image area and 0 in the non-moving-image area.

The metadata may be, for example, HyperText Markup Language (HTML) data of the input image. Here, to identify the moving image area, the identifying unit 101 reads position information included in the HTML data and indicating where the moving image area is, and converts, for each pixel in the input image, the position information into a 1-bit signal representing 1 in the moving image area and 0 in the non-moving-image area.

The identifying unit 101 crops and outputs the moving image area from the input image. An image (cropped image) corresponding to the cropped moving image area is written in a memory such as a Dynamic Random Access Memory (DRAM).

It is noted that, instead of writing the cropped image into the memory, the identifying unit 101 may add a synchronization signal to the cropped image and transmit the cropped image on the real-time basis.

Next, the camera shake amount calculating unit 102 calculates a camera shake amount of the cropped image (S102).

Specifically, the camera shake amount calculating unit 102 first detects an inter-frame motion vector of a moving image displayed in the moving image area. The motion vector is two-dimensional information representing that an object, which is displayed in an input image for a frame at a certain time, has moved to which position in the temporally subsequent frame. The motion vector may be detected for each pixel included in a cropped input image. The input image may be divided into a large number of processing blocks, and the motion vector may be detected for each of the processing blocks.

Next, the camera shake amount calculating unit 102 excludes, from among the detected motion vectors, a motion vector which should not be used for detection of camera shake.

For example, if the moving image includes a portion which shows no change in luminance at all, a motion vector cannot be detected in the portion. Hence, if a motion vector in such a portion is used for calculating a camera shake amount, the calculated camera shake amount is poor in accuracy.

Hence the camera shake amount calculating unit 102 extracts feature points of a cropped picture and uses, for calculation of the camera shake amount, only motion vectors corresponding to the feature points. Among points on an edge (a portion where a luminance change is drastic) of the moving image or among points found on an edge and located where the edge is bent at a sharp angle, a feature point may be a point including a feature useful for detecting a motion vector. The feature point shall not be limited to a specific one.

In addition, the camera shake amount calculating unit 102 may calculate the camera shake amount using only motion vectors with high reliability among the detected motion vectors. The reliability of a motion vector may be obtained from a correlation value in block matching.

Then, the camera shake amount calculating unit 102 counts how frequently a motion vector appears for each size of the detected motion vector, and creates a histogram. The histogram is created both for components for motion vectors in horizontal direction and for components for motion vectors in vertical direction.

Based on the created histogram for the motion vectors, the camera shake amount calculating unit 102 calculates, as the camera shake amount, the magnitude of the motion vector that has most frequently appeared. The camera shake amount is obtained for each of the horizontal direction and the vertical direction, and represented in the number of pixels.

In the above technique, the camera shake amount calculating unit 102 calculates, as the camera shake amount, the magnitude of the motion vector that has most frequently appeared; instead, the camera shake amount calculating unit 102 may calculate, as the camera shake amount, the average value of motion vectors.

Furthermore, the camera shake amount calculating unit 102 may calculate motion vectors for an entire input video, not for a moving image displayed in the moving image area. Here a still picture portion in the input video is small in magnitude of motion vectors. Hence the camera shake amount calculating unit 102 may calculate the camera shake amount using only motion vectors whose magnitudes are lager than a predetermined value. It is noted that, in such a case, the camera shake amount calculating unit 102 obtains an input image as the dashed arrow in FIG. 1 represents.

Next, the correction unit 103 generates a correction image (S103).

Using the cropped image and the camera shake amount, of the cropped image, calculated by the camera shake amount calculating unit 102, the correction unit 103 generates a correction image by correcting the camera shake of the cropped image. Then the correction unit 103 outputs the correction image to the compositing unit 104.

More specifically, the correction unit 103 shifts the cropped image for the number of pixels indicated in the camera shake amount which occurs in the horizontal and vertical directions and is calculated by the camera shake amount calculating unit 102.

For example, when the camera shake amount is x pixels in the horizontal direction and y pixels in the vertical direction, the correction unit 103 shifts the cropped image for −x pixels in the horizontal direction and −y pixels in the vertical direction. In other words, when the cropped image is entirely misaligned to right due to the camera shake, the correction unit 103 shifts, to left, a position where the cropped image is displayed. Such a feature makes it possible to fix, on the display screen, the position of the object captured in the moving image displayed in the moving image area, which contributes to removing the camera shake on the moving image.

FIG. 6 represents an example of how to correct a cropped image by shifting a read position within a memory space.

When directly reading a cropped image 403 as represented in the illustration (a) in FIG. 6, the correction unit 103 starts reading the cropped image at a read position 401a within a memory space 402.

In contrast, when generating a correction image as represented in the illustration (b) in FIG. 6, the correction unit 103 generates the correction image by starting to read the cropped image at a read position 401b to which the cropped image 403 is shifted, depending on the camera shake amount.

It is noted that the technique to generate the correction image shall not be limited to the above one. For example, when the cropped image is written into the memory, the identifying unit 101 may shift a write position, depending on the camera shake amount.

Moreover, for example, the correction unit 103 may shift a relative display position of the cropped image by shifting a synchronization signal added to the input video (the picture signal).

It is noted that the correction unit 103 may execute correction of the image in a rotational direction, in addition to image stabilization.

Finally, the compositing unit 104 generates a composite image in which the moving image area of the input image is composited with the correction image generated by the correction unit 103 (S105).

The position for compositing with the correction image, which is the position of the moving image area, is obtained from metadata. If the metadata is a 1-bit signal which represents 1 for the moving image area and 0 for the non-moving-image signal, the 1-bit signal is used as it is. If the metadata is a coordinate set of the moving image area, used is a 1-bit signal which is generated based on the coordinate set and represents 1 for the moving image area and 0 for the non-moving-image area.

### 1-3. Masking

Here, the composite image is an image with which the correction image is composited. The correction image is generated by shifting the original image depending on the camera shake amount. Hence the composite image has a portion where image data is missing at an end portion of the correction image composited with the composite image.

The compositing unit 104 masks the portion where the image data is missing in the composite image. The masking is processing to add predetermined image data to a portion of an image. It is noted that, in the description below, image data to be added is simply referred to as “mask”.

FIG. 7 represents an example of masking.

The compositing unit 102 executes masking which adds, for example, a single-color mask (image data having a single pixel value) to a portion where image data is missing (hereinafter an image made of a single pixel value is also referred to as solid image). Hence, as represented in FIG. 7, the solid image is displayed on the image data missing portion generated by the image stabilization of the correction unit 103.

Here the single color of the mask (the pixel value of the image data for the solid image) may be the average color of the correction image or may be a color of a portion which is included in the correction image and close to the image data missing portion.

Furthermore, the single color of the mask may be, for example, a color of a portion neighboring the moving image area and included in the non-moving-image area of the input image. Specifically, if the non-moving-image area is a text displaying area, a color for the background of the text displaying area is used as a single color for the mask. If the input image is pillerboxed or letterboxed, the same color as the color for the non-moving-image area represented in FIGS. 3 and 4 may be used as the color for the mask.

In addition, the compositing unit 104 may apply such masking as coping image data near a portion where image data is missing, by directly pasting the copied image data on the missing portion. Here the compositing unit 104 may further shade off the pasted image data or change the brightness (luminance) of the pasted image data. Furthermore, the compositing unit 104 may apply such masking as pasting, on the missing portion, an image data portion included in a moving image area of the input image one frame before and corresponding to the missing portion.

The masking may be applied at least on a portion where image data is missing. When the size of the image data missing portion changes, for example, the compositing unit 104 may apply such masking as pasting, on the missing portion, the same predetermined image data in size as the missing portion. In addition, the compositing unit 104 may apply such masking as always pasting image data in predetermined size (width).

Moreover, the compositing unit 104 may change a time period from when the masking is required to when a mask appears on the display screen and a time period from when the masking is no longer required and to when the displayed mask is cancelled.

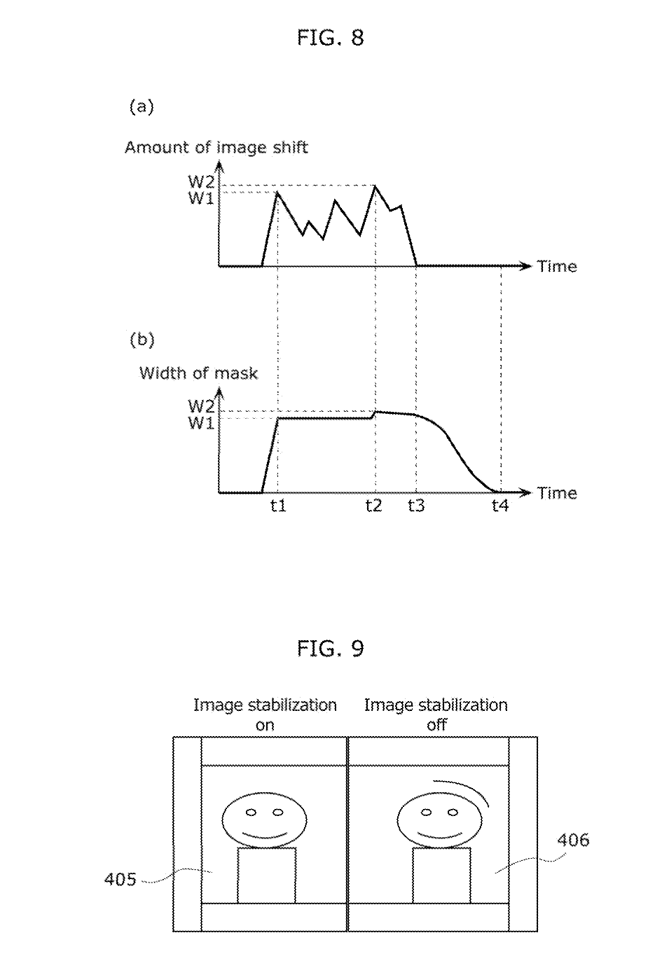

FIG. 8 represents how to control mask width (area).

The illustration (a) in FIG. 8 represents an amount of image shift when the correction unit 103 performs correction. The illustration (b) in FIG. 8 represents a width of a mask to be pasted by the compositing unit 104 on a composite image (a portion where data is missing on a correction image).

The examples in FIG. 8 show that the correction unit 103 performs the correction to generate a correction image for an input image whose moving image corresponding to a moving image area has a camera shake amount of a predetermined value or greater, and does not perform the correction for an input image whose moving image has a camera shake amount of smaller than the predetermined value.

When starting the masking as represented in FIG. 8, the compositing unit 104 applies the masking as soon as the correction unit 103 performs the correction (the time t1 in FIG. 8). Here, when applying the masking once, the compositing unit 104 applies the masking during a predetermined time period even though there is a change in the camera shake amount of the moving image in a moving image area, so that a mask having a constant width is pasted on a composite image (the time t1 through time t2 in FIG. 8). When the width of a portion where image data is missing is greater than the width of the mask pasted on the composite image, the compositing unit 104 pastes a mask with its width enlarged in order to cover the image data missing portion (the time t3 in FIG. 8).

The time period succeeding the time t3 in FIG. 3 sees little camera shake amount, and the correction unit 103 does not perform the correction. In other words, there is no data missing portion in the composite image. The compositing unit 104, however, continues the masking until the time t4. During the time period between t3 and t4, the compositing unit 104 controls the width of the mask so that the mask width narrows from inside the moving image area.

Such control allows the compositing unit 104 to apply more natural masking so that the mask width looks naturally reduced to the user.

It is noted that the image data missing portion for the masking is obtained from the camera shake amount calculated by the camera shake amount calculating unit 102.

### 1-4 Demonstration Mode

It is noted that the image processing device 100 may be set for a demonstration mode. Here the demonstration mode is a mode to simultaneously display, on the display screen, moving images before and after the image stabilization.

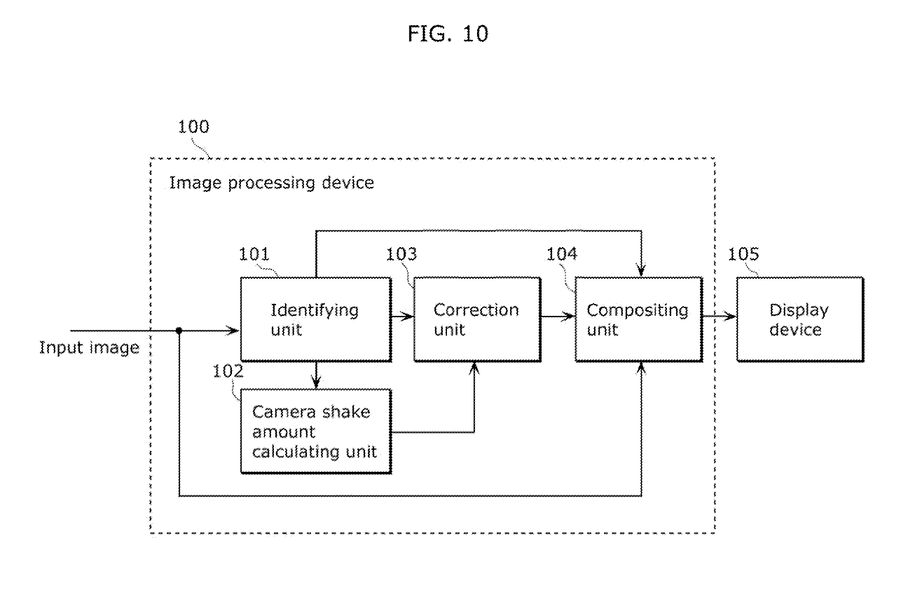

FIG. 9 represents the demonstration mode.

The image on the left of FIG. 9 is an image after correction 405. The image after correction 405 is an image including a moving image which the image processing device 100 has performed image stabilization thereon. In other words, the image after correction 405 is the correction image generated by the correction unit 103.

The image on the right of FIG. 9 is an image before correction 406. The image before 406 is a correction image before image stabilization. In other words, the image before 406 corresponds to a moving image area of an input image.

Here the image on the left and the image on the right in FIG. 9 are temporally synchronous with each other. Thus the demonstration mode allows the user to easily recognize the effect of image stabilization executed by the image processing device 100.

Described here is how to generate a composite image for the demonstration mode.

It is noted that, in the exemplary description below, a moving image (a third moving image) which is used for the demonstration mode is displayed on the entire display screen. In other words, the entire input image forms the third moving image.

First, the identifying unit 101 identifies, as the moving image area, a portion for the demonstration mode from the input image (one of frames in the third moving image). The portion set for the demonstration mode is arbitrarily determined in designing the demonstration mode and by a user input. Here an image corresponding to the identified moving image area will eventually be the image before correction 406 represented in FIG. 9.

Next, as described above, the camera shake amount calculating unit 102 calculates a camera shake amount of the moving image area, and the correction unit 103 generates a correction image.

Here the correction unit 103 employs the input image to generate the correction image to keep image data from missing. As described above, the correction image is generated of the image corresponding to the moving image area and shifted depending on the camera shake amount. Here, however, the entire input image forms a moving image, and the image data of the input image is found even though the image corresponding to the moving image area is shifted. Hence, there is no image data missing at an end portion of the correction image. In other words, the correction unit 103 can generate a correction image with no data missing portion.

Then the compositing unit 104 composites the correction image with the moving image area identified by the identifying unit 101. Hence the image after correction 405 is composited to be a composite image.

The compositing unit 104 further composites an image, which corresponds to the moving image area identified by the Identifying unit 101, with an area included in the input image and other than the moving image area. The compositing unit 104 composites the image corresponding to the above moving image area with the area so that the image and the area are horizontally arranged side-by-side. Hence the image before correction 406 represented in FIG. 9 is formed into the composite image represented in FIG. 9.

In the above demonstration mode, the correction image has no image missing portion. Hence no masking needs to be applied to the boundary portion between the image after correction 405 and the image before correction 406. Consequently, the user can easily compare on and off of the image stabilization executed by the image processing device 100.

It is noted that, in the demonstration mode, the masking may be applied as necessary. In FIG. 9, for example, the masking is applied to the vertical and horizontal end portions of the image.

### 1-5. Effects Etc.

As described above, the image processing device according to Embodiment 1 makes it possible to perform appropriate image stabilization under conditions where an input image, which is one of multiple frames included in an input video, includes (i) a moving image area and a non-moving-image area or (ii) multiple moving image areas.

Moreover, the masking applied by the image processing device according to Embodiment 1 makes it possible to reduce deterioration in moving image quality caused when a portion where image data is missing appears on an edge of a moving image area as a result of the image stabilization.

Such a feature allows the user to comfortably view a picture which partially includes a moving image with camera shake.

### Embodiment 2

In Embodiment 1, the identifying unit 101 obtains an input image and metadata which indicates the position of the moving image area in the input image, and identifies the moving image area using the obtained metadata. The identifying unit 101, however, may identify the moving image area without the metadata.

### [2-1. Structure]

FIG. 10 represents a block diagram illustrating a structure of an image processing device according to Embodiment 2.

The image processing device 100 represented in FIG. 10 differs from the image processing device 100 represented in FIG. 1 in how the identifying unit 101 identifies a moving image area.

### [2-2. Operations]

The identifying unit 101 identifies (detects) a moving image area included in an input image, and provides the camera shake amount calculating unit 102 and the compositing unit 104 with a moving image area identifying signal for identifying the moving image area.

In order to detect the position of the moving image area included in the input image, the identifying unit 101 first divides the input image into multiple processing target blocks and checks the number of colors used for each of the processing target blocks. Next, based on the number of colors used for each of the processing target blocks, the identifying unit 101 determines whether or not each processing target block is the moving image area or the non-moving-image area. Specifically, the identifying unit 101 determines that a processing target block using a great number of colors is a moving image area, and that a processing target block using a small number of colors is a non-moving-image area.

Hence, the identifying unit 101 may identify the moving image area without the metadata.

Furthermore, as another technique, the identifying unit 101 may divide an input video into multiple processing target blocks, calculate for each processing target block a difference in luminance between frames, and check whether or not a change (a change in luminance) is found in the processing target block. Here, the identifying unit 101 determines whether or not each of the processing target blocks whose difference in luminance between successive frames is greater than or equal to a predetermined value; that is, whether or not each processing target block is dynamic.

Here, the identifying unit 101 may calculate, for each of the processing target blocks, a difference in luminance between successive frames over a certain period. When the range in a period in which the successive frames are dynamic exceeds a predetermined value, the identifying unit 101 may determine that the processing target block as a dynamic processing target block.

Moreover, the identifying unit 101 may calculate, for each of the processing target blocks, a difference in luminance between successive frames over a certain period. When the range in a period in which the successive frames are static exceeds a predetermined value, the identifying unit 101 may determine that the processing target block as a static processing target block. As a result, the identifying unit 101 identifies a processing target block to be determined dynamic as the moving image area.

In addition, as another technique, the identifying unit 101 may identify a moving image area by calculating the average luminance for each of lines of an input image, detect a line which the average luminance does not smoothly match, and determine that the detected line is a boundary between a moving image area and a non-moving-image area. Specifically, the identifying unit 101 calculates the average luminance level for each of the lines in the horizontal direction and the virtual direction, obtains a difference between the average luminance levels of the lines, and, if the obtained difference exceeds a threshold, determines that the line is a boundary between the moving image area and the non-moving-image area.

Moreover, as still another technique, the identifying unit 101 detects motion vectors in an input image and identifies that a portion where a motion vector is not 0 is a moving image area. Here the motion vectors may be obtained for each of the pixels in the input image or for each of multiple processing target blocks into which the input image is divided.

Furthermore, the identifying unit 101 may detect motion vectors over a certain period. When the range in a period in which a motion vector is not 0 is greater than or equal to a predetermined value, the identifying unit 101 may determine that the pixel or the processing target block where the motion vector is not 0 is a moving image area. Furthermore, the identifying unit 101 may detect motion vectors over a certain period. When the range in a period in which the motion vector is 0 is greater than or equal to a predetermined value, the identifying unit 101 may determine that the pixel or the processing target block where the motion vector is 0 is a non-moving-image area.

As still another technique, if (i) an area having a certain width is provided to either the top and bottom of an Input image, the both sides of the input image, or a portion of the input image, and (ii) the area having the certain width is a black image appearing for a certain period, the identifying unit 101 may identify the area having the certain width as a non-moving-image area. This is the identification technique to be used when the input image is pillerboxed and letterboxed.

It is noted that the identifying unit 101 may independently use the above identification techniques, or may simultaneously use the identification techniques and compile the results of the identifications to obtain the final result of identifying the moving image area.

In addition, in dividing an input image into multiple processing target blocks to identify a moving image area, the identifying unit 101 may combine the results of identifications over the multiple processing target blocks. Specifically, if processing target blocks, which are determined as moving image areas, are neighboring each other and the entire neighboring processing target blocks form a rectangular area, the identifying unit 101 may determine that the rectangular area is a moving image area.

### [2-3. Effects Etc.]

As described above, the identifying unit 101 included in the image processing device 100 according to Embodiment 2 analyzes an input image to specify a moving image area, and outputs the resulting specification as a moving image area identifying signal. Hence even though metadata, which indicates the position of the moving image area in the input image, cannot be obtained, the image processing device 100 successfully identifies the moving image area and executes image stabilization only on the moving image in the moving image area.

### Embodiment 3

An input image may include multiple moving image areas.

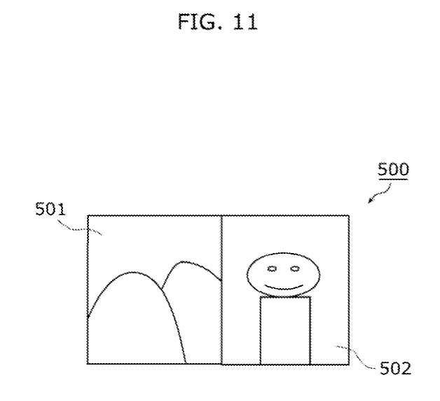

FIG. 11 represents an example of an input image displaying a two-screen display; that is to simultaneously display two moving images.

As represented in FIG. 11, an input image 500 includes a first moving image area 501 and a second moving image area 502. Each of the moving image areas may display a different moving image.

Hence an image processing device according to Embodiment 3 performs correction on multiple moving image areas in an input image.

### [3-1. Structure]

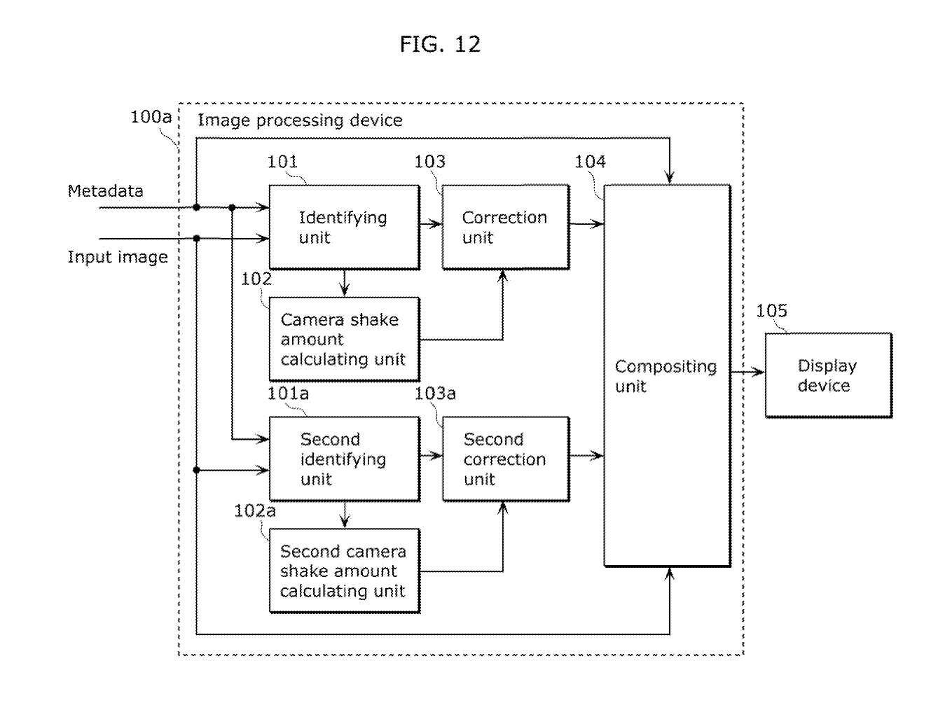

FIG. 12 represents a block diagram illustrating a structure of an image processing device according to Embodiment 3.

An image processing device 100a includes the identifying unit 101, the camera shake amount calculating unit 102, the correction unit 103, and the compositing unit 104. The image processing device 100 further includes a second identifying unit 101a, a second camera shake amount calculating unit 102a, and a second correction unit 103a. FIG. 12 also illustrates the display device 105 provided outside the image processing device 100.

The identifying unit 101, the camera shake amount calculating unit 102, and the correction unit 103 included in the image processing device 100a employ an input image and metadata on the input image, and execute image processing similar to the one executed on the first moving image area according to Embodiment 1.

Here the metadata according to Embodiment 3 is different from the metadata according to Embodiment 1, and indicates each of positions of the multiple moving image areas included in the input image. In the case of an input image 500 in FIG. 11, for example, the metadata is a multiple-bit signal which represents, for each of the pixels in the input image, “1” in a first moving image area 500 and “2” in a second moving image area 502. Such a feature makes it possible to identify each of the moving image areas.

It is noted that the metadata may indicate an (x, y) coordinate of each moving image area, as well as the width and height of the moving image area. Here, for each of the pixels in the input image, the identifying unit 101 identifies each of the moving image areas by converting information on the above coordinate, width, and height into a signal indicating a value corresponding to each moving image area.

### [3-2. Operations]

The other operations executed by the identifying unit 101, the camera shake amount calculating unit 102, and the correction unit 103 included in the image processing device 100a are similar to the operations described in Embodiment 1, and the description thereof shall be omitted.

The second identifying unit 101a, the second camera shake amount calculating unit 102a, and the second correction unit 103a included in the image processing device 100a perform image stabilization on the second moving image area, using an input image and metadata on the input image. The image stabilization is similar to the image stabilization described in Embodiment 1, and the description thereof shall be omitted.

The compositing unit 104 generates a composite image by compositing (i) a first correction image which is a correction image corresponding to the first moving image area and generated by the correction unit 103 with (ii) a second correction image which is a correction image corresponding to the second moving image area. It is noted that the position for compositing with the correction image, which is the position of the moving image area, is obtained from the metadata described in Embodiment 3.

Furthermore, as described in Embodiment 1, the compositing unit 104 masks a portion where image data is missing in the composite image. The compositing unit 104 individually masks each of an image data missing portion (a first missing portion) generated by the first correction image and an image data missing portion (a second missing portion) generated by the second correction image. The details of the masking are similar to those described in Embodiment 1, and the description thereof shall be omitted.

It is noted that the width of the mask may be individually set based on a camera shake amount for each of the first missing portion and the second missing portion, and may be set the same for the first missing portion and the second missing portion.

### [3-3. Effects Etc.]

As describe above, even though an input image includes multiple moving image areas, the image processing device 100a according to Embodiment 3 can individually execute image stabilization on each of the moving image area.

It is noted that the image processing device 100a includes two units each of an identifying unit, a camera shake amount calculating unit, and a correction unit. Here one of the identifying units may identify two or more moving image areas. Similarly, one of the camera shake amount calculating units may calculate camera shake amounts for two or more moving image areas, and one of the correction units may generate a correction image corresponding to two or more moving image areas.

It is noted that Embodiment 3 exemplifies the case where the input image is displaying so-called a two-screen display; instead, the image processing device 100a may execute similar image stabilization even in the case where the input image is a multi-screen display such as a three-screen display and a four-screen display.

In addition, Embodiment 3 exemplifies the case where the input image does not include a non-moving-image area; however, the input image may include a non-moving-image area.

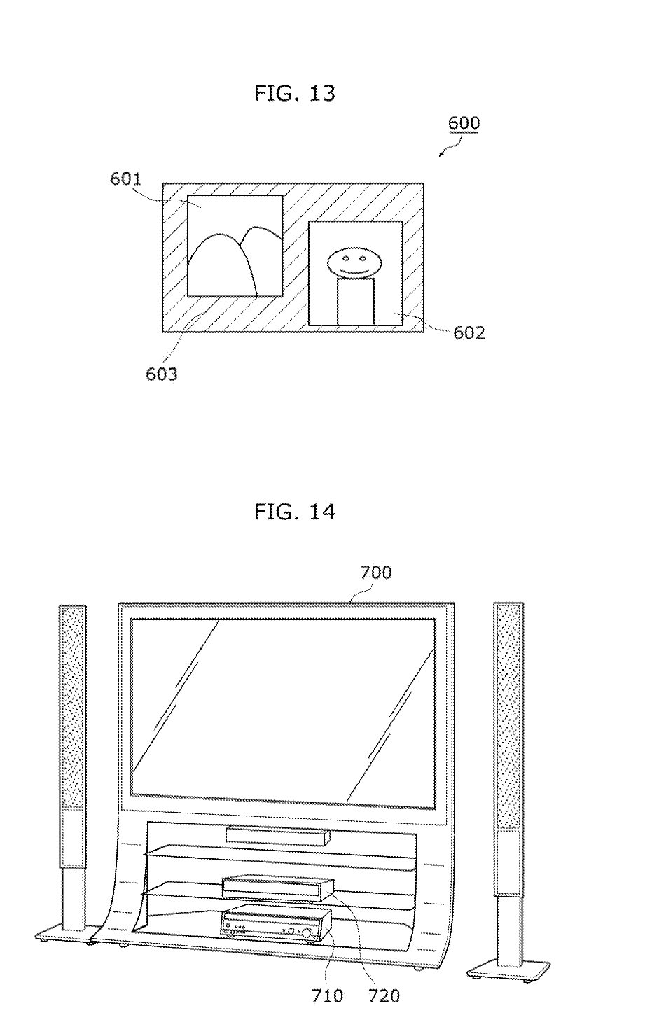

FIG. 13 represents an example of an input image including multiple moving image areas and a non-moving-image area.

Here the metadata is a signal which can identify a first moving image area 601, a second moving image area 602, and a non-moving-image area 603 that are included in an input image 600. The image stabilization is not executed on the non-moving-image area.

Furthermore, even though a non-moving-image area is included in an input image with a multiple-screen display presenting three or more screens, the image stabilization can be executed as well.

It is noted that the masking can be applied in a case where the input image wholly represents a moving image area, as well as cases where the input image is a multi-screen display and a portion of the input image is a moving image area as described in Embodiment 3.

### Other Embodiment

As described above, Embodiments 1 to 3 are exemplified as techniques to disclose the present application. The techniques according to the present disclosure, however, shall not be limited to the ones in the embodiments; instead, the techniques can be applied to an embodiment which is arbitrarily subject to modification, replacement, addition, and omission. Moreover, each of the constituent elements described in the above Embodiments 1 to 3 may be combined to form a new embodiment.

Described hereinafter together are other embodiments.

An image processing device according to an implementation of the present disclosure is implemented, for example, as a TV 700 represented in FIG. 14. Here the identifying unit obtains an input image (and metadata) from TV broadcast, a Blu-Ray player 710, and a set-top box 720 represented in FIG. 14.

Moreover, the image processing device according to an implementation of the present disclosure may be implemented as the Blu-Ray player 710. Here the identifying unit obtains an input image (and metadata) from an inserted Blu-Ray disc. It is noted that the input image does not have to be obtained only from a Blu-Ray disc. The identifying unit can obtain an input image from any given recording media such as a digital versatile disc (DVD) and a hard disc drive (HDD).

Furthermore, the image processing device may be implemented as the set-top box 720. Here the identifying unit obtains an input image from cable TV broadcasting and the like.

In addition, for example, a part or the entire image processing device according to Embodiments 1 to 3 may be implemented as a circuit in a form of dedicated hardware, and as a program executed on a processor. In other words, the cases below are also included in the present disclosure.

(1) Each of the aforementioned devices may be, specifically, a computer system including a microprocessor, a ROM, a RAM, a hard disk unit, a display unit, a keyboard, a mouse, and so on. The RAM or hard disk unit stores a computer program. The devices achieve their functions through the microprocessor's operation according to the computer program. Here the computer program is configured by combining instruction codes indicating instructions to the computer in order to achieve a predetermined function.

(2) A part or all of the constituent elements constituting the respective apparatuses may be configured from a single System-LSI (Large-Scale Integration). The System-LSI is a super-multi-function LSI manufactured by integrating constituent units on one chip. Specifically, the System-LSI is a computer system including a microprocessor, a ROM, a RAM, or by means of a similar device. The ROM stores a computer program. The System-LSI performs its functions through the microprocessor's loading the computer program from the ROM to the RAM and executing an operation such as calculation according to the loaded computer program.

(3) A part or all of the constituent elements constituting the each of the devices may be configured as an IC card which can be attached to and detached from each device or as a stand-alone module. The IC card or the module is a computer system configured from a microprocessor, a ROM, a RAM, and the like. The IC card or the module may also be included in the aforementioned super-multi-function LSI. The IC card or the module achieves its functions through the microprocessor's operation according to the computer program. The IC card or the module may also be implemented to be tamper-resistant.

(4) The present disclosure may be implemented in the above described techniques. Furthermore, the techniques may also be implemented in the form of a computer program executed on a computer or in the form of a digital signal including a computer program.

Moreover, the present disclosure may also be implemented in the form of the computer program or the digital signal stored in a computer readable recording medium such as a flexible disc, a hard disk, a CD-ROM, an MO, a DVD, a DVD-ROM, a DVD-RAM, a BD (Blu-ray Disc), and semiconductor memory. In addition, the present disclosure may be implemented in the form of the digital signal recorded in these recording media.

Furthermore, the present disclosure may also be implemented in the form of the aforementioned computer program or digital signal transmitted via a telecommunication line, a wireless or wired communication line, a network represented by the Internet, data broadcast, and the like.

Moreover, the present disclosure may also be a computer system including a microprocessor and a memory, in which the memory stores the aforementioned computer program and the microprocessor operates according to the computer program.

In addition, the above program or the above digital signal may be recorded on the above non-transitory computer-readable recording media for their transportation or transmitted via the above network in order to be executed on another independent computer system.

(5) The above embodiments and the above modifications may be combined one another.

### CONCLUSION

When an input image includes a moving image area and a non-moving-image area, an image processing device and an image processing method according to the embodiments can appropriately execute image stabilization only on the moving image area. Such a feature can reduce an unnecessary shake in the non-moving-image area when the image stabilization is executed on the non-moving-image area.

Furthermore, the image processing device and the image processing method according to the embodiments can mask a portion where image data is missing at an end portion of a moving image area. Such a feature makes it possible to look the image data missing portion, which occurs due to the image stabilization executed on the moving image area, less obvious to a user. In other words, the feature contributes to improving the display quality of an image.

Moreover, when an Input image includes multiple moving image areas, the image processing device and the image processing method according to the embodiments can appropriately execute image stabilization for each of the moving image areas. In other words, the image processing device and the image processing method can individually execute the image stabilization on two or more moving image areas included in the input image.

In addition, the image processing device and the image processing method can execute masking such as changing the color for a mask portion depending on the color of a moving image area. Such a feature makes it possible to look the masking in action less obvious.

As described above, the embodiments are exemplified as techniques according to the present disclosure. For the embodiments, the drawings are attached and the detailed description is provided.

Accordingly, the constituent elements described in the attached drawings and the detailed description may include not only constituent elements which are essential for solving the problems but also constituent elements which are not essential for solving the problems but are introduced for exemplifying the above techniques. Hence the constituent elements, which might not be essential and are included in the attached drawings and the description, shall not be instantly recognized as essential ones.

Furthermore, the embodiments are for exemplifying the techniques in the present disclosure, and may include various modifications, replacement, addition and omission which are equivalent to and within the scope of the claims.

### INDUSTRIAL APPLICABILITY

An image processing device according to the present disclosure can remove a camera shake from a moving image area which is a part of an Input image, and is useful as a display device such as a TV.

### REFERENCE SIGNS LIST

100 and 100a Image processing device
101 Identifying unit
101a Second identifying unit
102 Camera shake amount calculating unit
102a Second camera shake amount calculating unit
103 Correction unit
103a Second correction unit
104 Compositing unit
105 Display device
200, 300a, 300b, 500, and 600 Input image
201, 301a, and 301b Moving image area
202, 302a, 302b, and 603 Non-moving-image area
401a and 401b Read position
402 Memory space
403 Cropped image
405 Image after correction
406 Image before correction
501 and 601 First moving image area
502 and 602 Second moving image area
700 TV
710 Blu-Ray player
720 Set-top box

1. An image processing device which executes image processing on an input image, the image processing device comprising:
an identifying unit configured to identify a first moving image area which is a portion of the input image and includes a first moving image;
a camera shake amount calculating unit configured to calculate a camera shake amount in the first moving image area;
a correction unit configured to generate a first correction image by correcting the first moving image area to reduce the camera shake amount; and
a compositing unit configured to generate a composite image by replacing the first moving image area in the input image with the first correction image.

2. The image processing device according to claim 1,
wherein the compositing unit is further configured to apply masking by pasting predetermined image data on an image data missing portion resulting from correcting the first moving image area and included in the composite image.

3. The image processing device according to claim 2,
wherein the input image is one of frames included in an input video,
the correction unit is configured to perform correction to generate the first correction image only for the input image in which the first moving image area has a camera shake amount of a predetermined value or greater, and
if (i) the correction unit performs the correction on and the compositing unit applies the masking to a first frame which is the input image where a camera shake amount in the first moving image area is greater than or equal to a predetermined value and (ii) a camera shake amount in the first moving image area is smaller than a predetermined value in a second frame which is the input image immediately after the first frame, the compositing unit is configured to apply the masking to the second frame.

4. The image processing device according to claim 3,
wherein if a camera shake amount in the first moving image area is smaller than a predetermined value in a third frame which is the input image immediately after the second frame, the compositing unit is configured to apply the masking to the third frame,
an area to which the masking is applied in the second frame is smaller than an area to which the masking is applied in the first frame, and
an area to which the masking is applied in the third frame is smaller than the area to which the masking is applied in the second frame.

5. The image processing device according to claim 2,
wherein the compositing unit is configured to apply the masking by pasting, as the predetermined image data, image data neighboring the first moving image area or image data of the first correction image.

6. The image processing device according to claim 1,
wherein the identifying unit is configured to obtain the input image and metadata which indicates a position of the first moving image area in the input image, and identify the first moving image area using the obtained metadata.

7. The image processing device according to claim 1,
wherein the identifying unit is configured to detect a motion vector of the input image using frames included in the input video, and identify the first moving image area using the detected motion vector.

8. The image processing device according to claim 1,
wherein the identifying unit is further configured to identify a second moving image area which (i) differs from the first moving image area in the input image and (ii) includes a second moving image that differs from the first moving image,
the camera shake amount calculating unit is further configured to calculate a camera shake amount in the second moving image area,
the correction unit is further configured to generate a second correction image by correcting the second moving image area to reduce the camera shake amount in the second moving image area, and
the compositing unit is further configured to generate the composite image by replacing the second moving image area in the input image with the second correction image.

9. The image processing device according to claim 1,
wherein the compositing unit is configured to generate the composite image by further compositing an image corresponding to the first moving image area with an area of the input image other than the first moving image area.

10. The image processing device according to claim 9,
wherein the input image wholly represents a third moving image,
the identifying unit is configured to identify the first moving image area including the first moving image that is a portion of the third moving image, and
the correction unit is configured to generate the first correction image by correcting, to keep image data from missing, the first moving image area based on the camera shake amount using the input image.

11. An image processing method for executing image processing on an input image, the image processing method comprising:
identifying a first moving image area which is a portion of the input image and includes a first moving image;
calculating a camera shake amount in the first moving image area;
generating a first correction image by correcting the first moving image area to reduce the camera shake amount; and
generating a composite image by replacing the first moving image area in the input image with the first correction image.
